(19) United States
(12) Patent Application Publication
(10) Pub. No.: US 2012/0037728 A1
(43) Pub. Date: Feb. 16, 2012

(54) DUAL NOZZLE CAP FOR THERMAL SPRAY COATING

(76) Inventor: Byung Doo Kim, Seoul (KR)

(21) Appl. No.: 12/869,424

(22) Filed: Aug. 26, 2010

(30) Foreign Application Priority Data
Aug. 13, 2010 (KR) 10-2010-0078040

(51) Int. Cl. B05B 1/14

(52) U.S. Cl. 239/554

(57) ABSTRACT

Disclosed is a dual nozzle cap for thermal spray coating to which both a thermal spray coating method and a kinetic spray coating method are applied. The dual nozzle cap includes a nozzle unit including inner and outer nozzles, a gun insertion hole, into which the front end of a spray gun is inserted, and a gas connection hole, into which a gas connector to supply the gas is inserted, formed through one surface of the nozzle unit. In a space between the inner and outer nozzles, a gas collection part to uniformly distribute the high-pressure subsidiary gas injected through the connection hole, a neck part to apply pressure to the high-pressure subsidiary gas to accelerate the subsidiary gas, and a gas spray hole to spray the subsidiary gas supplied from the neck part together with a material sprayed from the spray gun are sequentially formed.

### BACKGROUND OF THE INVENTION

1. Field of the Invention

The present invention relates to a dual nozzle cap for thermal spray coating, and more particularly to an apparatus which is attached to a region of a spray gun around a flame spray hole and thus allows subsidiary gas separately injected to be sprayed together with sprayed flame so as to adjust velocity, temperature, and purity of the sprayed flame.

2. Description of the Related Art

As is generally known, thermal spraying is carried out through a thermal spray coating method in which a coating material, such as a linear material or metal powder, is melted at a high temperature and then is sprayed to perform coating, and a kinetic spray coating method in which powder for coating is melted by collision energy, generated when the coating powder is sprayed toward the surface of a base material to be coated at a high pressure and a high velocity and thus collides with the surface of the base material, to perform coating. Such a thermal spray coating method is divided into a gas type and an electric type according to the kind of a heat source used to heat the coating material. The gas type thermal spray coating method includes flame spraying, detonation spraying, and high velocity oxygen fuel (HVOF) spraying, and the electric type thermal spray coating method includes arc spraying, plasma spraying, wire explosion spraying, and laser spraying. Recently, techniques for plasma spray which enables miniaturization of an apparatus and generates high-temperature heat, and thus uses a coating material having a high melting point, such as W or Mo, have been vigorously developed. For example, there is Korean Patent Laid-open Publication NO. 10-2008-0082283 (Title: Plasma Spray Coating Method; hereinafter, referred to as ‘Cited Reference’).

A thermal spray process includes performing pre-treatment or roughing the surface of a base material to be coated by applying impact to the surface of the base material so as to obtain weld-strength of the base material, forming a coating layer on the surface of the base material by melting and spraying a coating material, such as a linear material or metal powder, and performing post-treatment to improve coating properties of the coating layer after spraying. In such a thermal spray process, if the base material is a general crystalline metal, impact or heat generated during the pre-treatment or the spraying causes fine cracks between crystals of the metal or peeling-off of fine crystals of the metal to form an uneven surface of the base material having depressions, and the molten coating material is sprayed and fills the cracks or the depressions, thereby achieving a coating layer. On the other hand, a plasma spray coating process disclosed in Cited Reference further includes preparing a substrate, one surface of which is substantially parallel with a direction of gravity, so as to increase a coating density without re-absorption of scattered particles reflected due to collision with a base material during plasma spray coating, and spraying a plasma flame, which is generated due to a pressure difference between a cathode and an anode and mixed with molten ceramic powder, onto the surface of the substrate in a direction perpendicular to the direction of gravity.

However, new materials, i.e., amorphous metals having far higher strength and repulsive force than conventional crystalline metals, have been developed. If such an amorphous metal is applied to the conventional thermal spray coating method as in Cite Reference in which ceramic powder is mixed with the coating material or a spraying direction is varied, the amorphous metal oxidizes and thus the amorphous property of the amorphous metal is rapidly lowered.

### SUMMARY OF THE INVENTION

Therefore, the present invention has been made in view of the above problems, and it is an object of the present invention to provide a dual nozzle cap for thermal spray coating in which a kinetic spray coating method is applied to a thermal spray coating-type spray gun so as to increase directionality in spraying and spray velocity.

In accordance with the present invention, the above and other objects can be accomplished by the provision of a dual nozzle cap for thermal spray coating, which is mounted at the front end of a spray gun, the dual nozzle cap including a nozzle unit including an inner nozzle and an outer nozzle, a gun insertion hole, into which the front end of the spray gun is inserted, formed at the center of the nozzle unit, and a gas connection hole formed through one surface of the nozzle unit to supply high-pressure subsidiary gas, wherein, in a space between the inner nozzle and the outer nozzle of the nozzle unit, a gas collection part to distribute the high-pressure subsidiary gas, injected through the connection hole, throughout the inside of the nozzle unit, a neck part to apply pressure to the high-pressure subsidiary gas filling the gas collection part so as to elevate the pressure of the high-pressure subsidiary gas, accelerate the high-pressure subsidiary gas, and provide directionality when spraying the subsidiary gas, and a gas spray hole formed in a ring-shaped space at the end of the nozzle part to spray the subsidiary gas, provided with the elevated pressure and accelerated velocity by the neck part, together with a material sprayed from the spray gun are sequentially formed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a detailed configuration of a dual nozzle cap for thermal spray coating in accordance with the present invention;

FIG. 2 is a sectional perspective view illustrating an internal structure of the dual nozzle cap for thermal spray coating in accordance with the present invention;

FIG. 3 is a sectional view of the dual nozzle cap for thermal spray coating in accordance with the present invention; and

FIG. 4 is a sectional view of the dual nozzle cap for thermal spray coating, which is connected with a spray gun, in accordance with the present invention.

### DETAILED DESCRIPTION OF THE INVENTION

Now, a preferred embodiment of the present invention will be described in detail with reference to the annexed drawings.

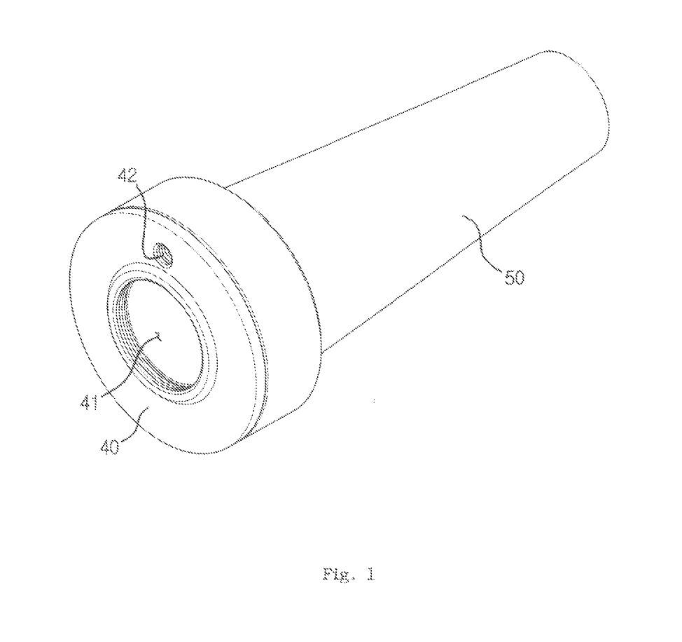

FIGS. 1 to 3 illustrate an overall configuration of a dual nozzle cap for thermal spray coating in accordance with one embodiment of the present invention.

As shown in FIGS. 1 to 3, the dual nozzle cap for thermal spray coating in accordance with the present invention is mounted at a front end of a spray gun 10. The dual nozzle cap for thermal spray coating includes an inner nozzle 40 provided with a gun insertion hole 51, into which the front end of the spray gun 10 is inserted, formed at the center of the inner nozzle 40, and an outer nozzle 50 surrounding the outer circumferential surface of the inner nozzle 40 and concentrically connected with one side of the inner nozzle 40. A ring-shaped space is formed between the inner nozzle 40 and the outer nozzle 50 so as to accelerate subsidiary gas 21 injected into the space between the inner nozzle 40 and the outer nozzle 50.

Here, as the spray gun 10, any conventional spray guns, including a thermal spray gun, a plasma spray gun, a flame gun, and an arc spray gun, may be used. Further, a connection nozzle to connect the front end of the spray gun 10 to the dual nozzle cap in accordance with the present invention may be interposed between the front end of the spray gun 10 and the dual nozzle cap.

Hereinafter, the respective components of the dual nozzle cap in accordance with the present invention will be described in more detail.

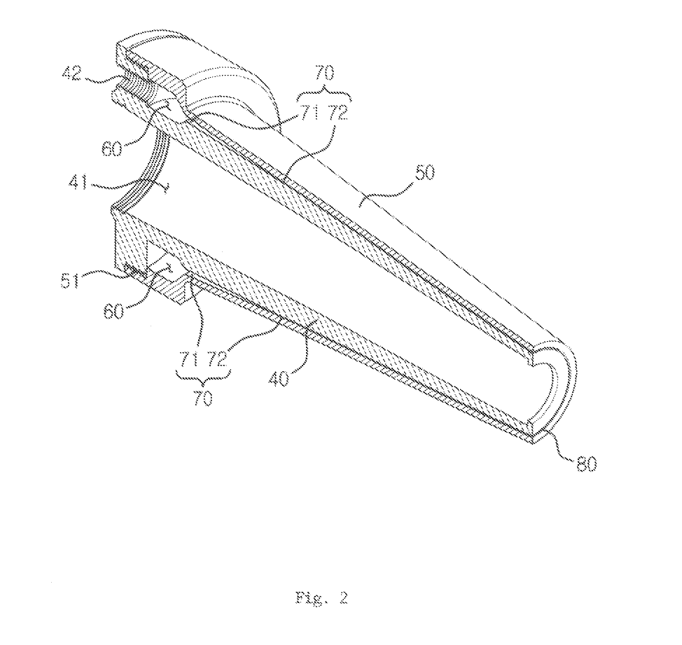

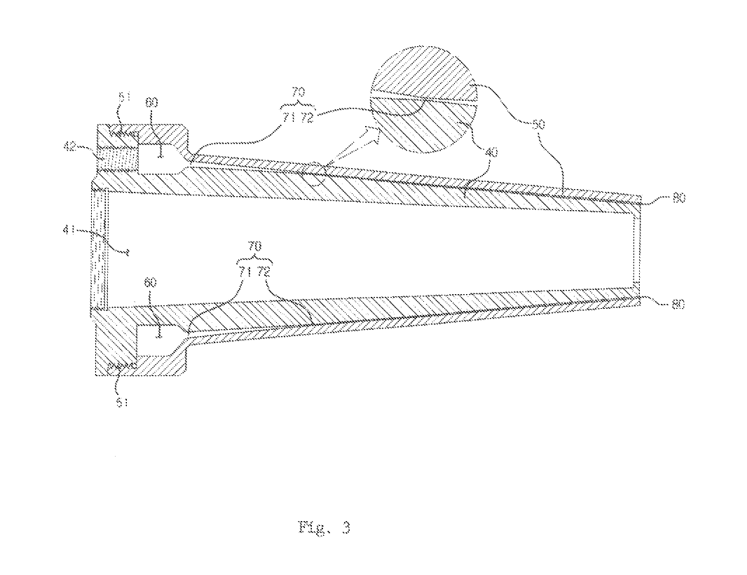

A connection hole 42, to which a connector 20, such as a gas supply pipe, through which the subsidiary gas 21 of a high pressure is supplied to the dual nozzle cap, is connected, is formed through one surface of either of the inner nozzle 40 or the outer nozzle 50. The connection hole 42, as shown in FIGS. 2 and 3, may be formed in parallel with the gun insertion hole 41 so that injection force of the high-pressure subsidiary gas 21 injected from the connector 20 is applied to a neck part 70 so as to further raise the elevated pressure. On the contrary, the connection hole 42 may be formed perpendicularly to the gun insertion hole 41 so that the high-pressure subsidiary gas 21 injected into the dual nozzle cap is momentarily distributed uniformly. Further, as needed, two or more connection holes 42 may be formed.

In the dual nozzle cap in accordance with the present invention, as shown in FIG. 3, the inner nozzle 40 and the outer nozzle 50 are interconnected so as to sequentially form a gas collection part 60, the neck part 70, and a gas spray hole 80 between the inner nozzle 40 and the outer nozzle 50. The gas collection part 60 uniformly distributes the high-pressure subsidiary gas 21, injected through the connection hole 42, throughout the space between the inner nozzle 40 and the outer nozzle 50. The neck part 70 applies pressure to the high-pressure subsidiary gas 21 filling the gas collection part 60, thereby elevating the pressure of the high-pressure subsidiary gas 21 and accelerating the velocity of the high-pressure subsidiary gas 21. The gas spray hole 80 is formed in a space having a ring-shaped cross section between other ends of the inner nozzle 40 and the outer nozzle 50, and sprays the subsidiary gas 21 provided with the elevated pressure and accelerated velocity by the neck part 70 with a designated directionality while preventing diffused spray of a material from the spray gun 10.

Further, the inner nozzle 40 and the outer nozzle 50 may not be formed separately, but may be integrated into a single nozzle unit such that the above-described gun insertion hole 41, connection hole 42, air collection part 60, neck part 70, and air spray hole 80 may be formed within the nozzle unit.

Here, the above neck part 70, as shown in FIG. 3, includes a first neck region 71 rapidly narrowed from one side of the gas collection part 60 so as to elevate the pressure of the subsidiary gas 21 within the gas collection part 60, and a second neck region 72 gradually narrowed and then gradually widened from the first neck region 71 to the air spray hole 80 so as to prevent diffused spray of the subsidiary gas 21 with the elevated pressure, introduced from the first neck region 71, and to uniformly maintain directionality when spraying the subsidiary gas 21. Thereby, when the subsidiary gas 21 injected to the inside of the dual nozzle cap through the connection hole 42 at a high pressure fills the gas collection part 60, the subsidiary gas 21 is continuously supplied into the dual nozzle cap, the subsidiary gas 21 flows to the neck part 70 formed at one side of the gas collection part 60. Then, the pressure of the high-pressure subsidiary gas 21 is elevated by the first neck region 71 rapidly narrowed from the side of the gas collection part 60 in the same manner as the principle of a jet engine, and thus the subsidiary gas 21 is accelerated and flows at a superhigh velocity.

Thereafter, when the subsidiary gas 21 flows along a gradually narrowed section of the second neck region 72, gradually narrowed and then gradually widened from the first neck region 71 to the air spray hole 80, the pressure of the subsidiary gas 21 is continuously elevated and thus the subsidiary gas 21 is accelerated, and then when the subsidiary gas 21 flows along a gradually widened section of the second neck region 72, the diffused subsidiary gas 21 is concentrated in a spray direction so as to uniformly maintain directionality when spraying the subsidiary gas 21. Therefore, the superhigh-velocity/superhigh-pressure subsidiary gas 21 having the uniform directionality when spraying the subsidiary gas 21 is sprayed through the gas spray hole 80.

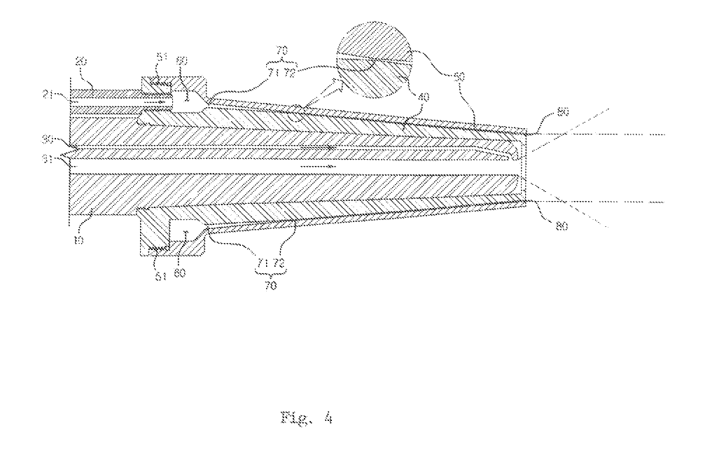

Further, the gas spray hole 80 provided at the end of the second neck region 72, as shown in FIG. 2, is formed in a ring-shaped space around the other end of the inner nozzle 40 having a narrow outer surface. Therefore, as shown in FIG. 4, the superhigh-velocity/superhigh-pressure subsidiary gas 21 sprayed from the gas spray hole 80 surrounds the material sprayed from the spray gun 10 so as to prevent the sprayed material from coming into contact with oxygen in the air, has uniform directionality, and is sprayed at a much greater velocity than the sprayed material so as to concentrate the diffusedly sprayed material in the spray direction and accelerate the sprayed material to a superhigh velocity, thereby suppressing oxidation of an amorphous metal, an amorphous property of which is rapidly lowered due to oxidation, and thus producing a high-quality thermal spray coating layer having a high amorphous property.

Although FIG. 4 exemplarily illustrates that the conical dual nozzle cap in accordance with the present invention is mounted at the front end of the thermal spray gun 10, which melts metal powder 30 using heat of combustion, generated from combustion of fuel gas 31, such as methane, ethane, propane, butane, or ethylene, with oxygen, and then sprays the molten powder 30, the dual nozzle cap in accordance with the present invention may be applied to other types of spray guns, such as a plasma spray gun.

Here, the powder 30 may be a coating material for thermal spray coating, such as one of thermoplastic polymeric materials, i.e., thermopolymers, which may be melted without serious degradation, as well as a metal. Such thermopolymers include polyethylene (low density or high density), polypropylene (low density or high density), polyurethane (Low density or high density), nylon (for example, nylon 6 or nylon 11), nylon copolymer, EVA, EEA, ABS, PVC, PEEK, PVDF, PTFE (for example, Teflon®) and other fluorocarbon polymers, polycarbonate, acrylics, polyether, polyester, epoxy resins, silicon, and their chemical or physical combinations. In addition, the themopolymers may include zinc, aluminum, zinc-aluminum alloys, ferrous metal alloys, clad powder of copper and copper alloys, ceramics, carbon, graphite, electromagnetic shielding materials, electric conductors, fluorescent materials, phosphorescent materials, reflective materials, radar absorbing materials, and functional components, such as UV protectors and anti-microbial agents.

A base material, to which the coating layer is applied, includes porous or non-porous metals (for example, steel and aluminum), wood, cork, glass, ceramics, solid or foamed polymeric materials, and paper-containing materials.

Thermal spray coating using the dual nozzle cap in accordance with the present invention may be applied to bridges, transportation facilities, buildings, road signs, or various constructions in marine environments, such as wharfs or piers. That is, when the dual nozzle cap in accordance with the present invention is applied to a conventional thermal spray gun, the dual nozzle cap may achieve temperature adjustment and prevention of contact of a material sprayed from the thermal spray gun with oxygen in the air, thereby allowing the above-described materials, which were not sprayed with the conventional thermal spraying or spray velocity, to be sprayed, and enabling a wide selection range of subjects to be coated.

As apparent from the above description, a dual nozzle cap for thermal spray coating in accordance with the present invention provides uniform directionality when spraying subsidiary gas and continuously applies pressure to the subsidiary gas through a gas collection part and a neck part so that the superhigh-velocity subsidiary gas sprayed through a gas spray hole is sprayed together with a material sprayed from a spray gun while surrounding the material, thus accelerating the sprayed material to a superhigh velocity and concentrating a spraying direction. Thereby, the dual nozzle cap in accordance with the present invention prevents the sprayed material from coming into contact with oxygen in the air, increases spray pressure and velocity, and reduces spray temperature, thereby allowing an amorphous metal having high strength and repulsive force to be sprayed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A dual nozzle cap for thermal spray coating, which is mounted at the front end of a spray gun, the dual nozzle cap comprising:
an inner nozzle provided with a gun insertion hole, into which the front end of the spray gun is inserted, formed at the center of the inner nozzle; and
an outer nozzle surrounding the outer circumferential surface of the inner nozzle, and connected with one side of the inner nozzle,
wherein a ring-shaped space is formed between the inner nozzle and the outer nozzle so as to accelerate subsidiary gas injected into the space between the inner nozzle and the outer nozzle.

2. The dual nozzle cap for thermal spray coating according to claim 1, wherein a gas connection hole, through which the high-pressure subsidiary gas is supplied to the space between the inner nozzle and the outer nozzle, is formed through one surface of either of the inner nozzle or the outer nozzle.

3. The dual nozzle cap for thermal spray coating according to claim 2, wherein, between the inner nozzle and the outer nozzle, a ring-shape gas collection part to uniformly distribute the high-pressure subsidiary gas injected through the gas connection hole, a neck part to apply pressure to the high-pressure subsidiary gas filling the gas collection part so as to elevate the pressure of the high-pressure subsidiary gas, accelerate the high-pressure subsidiary gas, and provide directionality when spraying the subsidiary gas, and a gas spray hole formed around the other end of the inner nozzle to spray the subsidiary gas, provided with the elevated pressure and accelerated velocity by the neck part, together with a material sprayed from the spray gun are sequentially formed.

4. The dual nozzle cap for thermal spray coating according to claim 3, wherein the gas connection hole is formed in a direction parallel with the gun insertion hole.

5. The dual nozzle cap for thermal spray coating according to claim 3, wherein the neck part includes a first neck region rapidly narrowed from one side of the gas collection part so as to elevated the pressure of the subsidiary gas within the gas collection part, and a second neck region gradually narrowed and then gradually widened from the first neck region to the air spray hole so as to prevent diffused spray of the subsidiary gas with the elevated pressure, introduced from the first neck region, and to uniformly maintain directionality when spraying the subsidiary gas.

6. A dual nozzle cap for thermal spray coating, which is mounted at the front end of a spray gun, the dual nozzle cap comprising:
a nozzle unit including an inner nozzle and an outer nozzle;
a gun insertion hole, into which the front end of the spray gun is inserted, formed at the center of the nozzle unit; and
a gas connection hole formed through one surface of the nozzle unit to receive high-pressure subsidiary gas,
wherein, in a space between the inner nozzle and the outer nozzle of the nozzle unit, a gas collection part to uniformly distribute the high-pressure subsidiary gas injected through the gas connection hole, a neck part to apply pressure to the high-pressure subsidiary gas filling the gas collection part so as to elevate the pressure of the high-pressure subsidiary gas, accelerate the high-pressure subsidiary gas, and provide directionality when spraying the subsidiary gas, and a gas spray hole formed in a ring-shaped space between the inner nozzle and the outer nozzle at the end of the nozzle part to spray the subsidiary gas, provided with the elevated pressure or accelerated velocity by the neck part, together with a material sprayed from the spray gun are sequentially formed.

7. The dual nozzle cap for thermal spray coating according to claim 6, wherein the gas connection hole is formed in a direction parallel with the gun insertion hole.

8. The dual nozzle cap for thermal spray coating according to claim 6, wherein the neck part includes a first neck region rapidly narrowed from one side of the gas collection part so as to elevate the pressure of the subsidiary gas within the gas collection part, and a second neck region gradually narrowed and then gradually widened from the first neck region to the air spray hole so as to prevent diffused spray of the subsidiary gas with the elevated pressure, introduced from the first neck region, and to uniformly maintain directionality when spraying the subsidiary gas.
